(19) United States
(12) Patent Application Publication
(10) Pub. No.: US 2026/0024026 A1
(43) Pub. Date: Jan. 22, 2026

(54) SYSTEMS AND METHODS FOR AUTOMATED, INSPIRATION-BASED TRAVEL ITINERARY GENERATION

(71) Applicants: Peter deVroede, Piedmont, CA (US); Brice Alan Dreamer, Allschwill (CH); Matthew Joseph Ruth, Scottsdale, AZ (US)

(72) Inventors: Peter deVroede, Piedmont, CA (US); Brice Alan Dreamer, Allschwill (CH); Matthew Joseph Ruth, Scottsdale, AZ (US)

(21) Appl. No.: 19/274,502

(22) Filed: Jul. 19, 2025

Related U.S. Application Data
(60) Provisional application No. 63/673,362, filed on Jul. 19, 2024.

(51) Int. Cl. G06Q 10/02; G06Q 50/14; G06V 10/40; G06V 20/10

(52) U.S. Cl. CPC G06Q 10/02; G06Q 50/14; G06V 10/40; G06V 20/10

(57) ABSTRACT

A system is configured to receive and collect raw, unstructured, and unorganized travel information from users via a computing device. This information can be received via messaging, for example, but not limited to SMS, or MMS. Information can also be shared through a mobile application, or direct entry into a website. These elements of information can take the form of web page URLs, social media posts, images, audio, and videos. In the described system, these elements of inspiring travel information are referred to as “Sparks.” The system includes a method by which the user can view and manage their Sparks. The system analyzes the Sparks the user has gathered to extract specific travel features and assembles various subsets of the collected travel features into travel itineraries. By relying on user-curated content, the system provides more current and accurate travel plans compared to those based on static databases.

### FIELD OF INVENTION

The present invention relates to a travel planning system, specifically a system that collects user-generated travel inspirations and organizes them into comprehensive travel itineraries using an AI-driven automated process.

### BACKGROUND

### The Travel Planning Process

Travel planning is generally undertaken in four stages: inspiration, research, planning, and booking. Today, travelers typically utilize multiple disconnected tools or resources in each phase.

### Inspiration

During this phase, the traveler encounters various pieces of information about new locales on the web, on social media, etc., that they find interesting. The traveler may be very intentional about this discovery process, or they may come across content they find interesting through their normal consumption of content.

There are many travel-related resources available that prospective travelers can use for inspiration. This includes websites, magazine articles, YouTube videos, and even television programs. However, travel-specific tools for gathering, managing, and organizing inspirational content are not generally available. Avid travelers often save this type of information in a collection using a variety of tools, including social media, map applications, and spreadsheets. While some systems do in fact allow users to collect travel-related content (such as that described in 10,445,666 B and to some degree 7,925,540 B), those systems do so in the context of a destination a traveler is already intending to visit. At the point of committing to gathering specific information for a specific location is extremely late in the inspiration process. As such, the usefulness of such systems as a true inspiration tool is limited.

Some existing solutions address later stages of travel planning but not this early phase. For example, itinerary-focused applications such as Wanderlog and TourSoft often assume that the traveler has already selected a destination. Similarly, AI-driven platforms like Trip Planner AI, Wonderplan, layla.ai, mindtrip.ai, and Roam Around typically require users to input structured preferences (e.g., budget, dates, and known destinations) before generating recommendations. Social discovery tools such as Pinterest, Instagram, and TikTok provide inspiration but lack mechanisms to organize or operationalize that content for trip planning. These approaches are not designed to capture or organize unstructured inspirations as they occur.

The disclosed system differs by providing a mechanism to capture such inspirations at the moment they occur, regardless of format (e.g., URLs, text, images), and to automatically extract and organize the relevant travel elements for future use. This allows inspiration to serve as the starting point for the entire planning process, unlike current solutions that treat inspiration as disconnected or optional.

### Research

Once the traveler has decided to seriously plan their travel, either as part of their regular vacationing process or when inspired by some particular information or content about a location(s), they will generally begin a more directed research effort. This can be for a single, specific location, but often leads to the moment of deciding between multiple options (usually 2-3). This may involve inspecting their saved collection of travel information and determine which materials would be most relevant to the destination they're researching. They may begin to research some of the locales they know less about and may begin to look at maps to determine which group of locales would potentially make the most sense as a trip.

Resources used here include guidebooks, magazines, and websites. Existing digital platforms in this category typically focus on surfacing destination-specific guides, providing prebuilt itineraries, or leveraging AI to suggest trips based on user inputs. Examples include platforms such as Lonely Planet, which offers curated destination guides, Culture Trip, which combines editorial content with trip suggestions, and Triposo, which provided AI-based recommendations (Triposo is no longer operational). These systems still generally assume the user has narrowed down their choices and is ready to make more structured decisions.

The disclosed system enables a different workflow by connecting research directly to the inspirations already collected by the user. Rather than starting from scratch, the traveler can filter and explore information derived from their saved sparks, allowing AI-driven clustering and enrichment to bridge the gap between loosely defined ideas and concrete research.

### Planning

As an itinerary for the trip begins to materialize for the traveler, they will begin to block out a loose itinerary. Research continues as itinerary planning requires increasingly detailed information. As detailed information is collected, logistics may force locales to be dropped off the list, and the traveler may seek out additional locales or attractions that fit the remaining locales better from a logistical perspective.

Several tools currently serve this phase, including itinerary-building applications and productivity-style planning platforms. Examples include Triplt, which organizes itineraries from confirmation emails, and Roadtrippers, which specializes in road trip route planning. Other tools like Sygic Travel provide day-by-day planners with maps, while general productivity tools such as ClickUp or Notion are often adapted for collaborative trip planning. AI-driven itinerary generators exist but typically operate in isolation, requiring structured inputs and creating itineraries from scratch rather than leveraging the traveler's authentic inspirations as building blocks.

The disclosed system enables itinerary planning to occur as a natural extension of inspiration and research, using the traveler's curated sparks and AI-powered sequencing rather than generic templates.

### Booking

Once the itinerary has been planned, the traveler or travel agent can begin to book travel, accommodations, activities, etc.

In reality, these steps are seldom performed in that strict order. Actual travel planning often involves some amount of back-and-forth between the various stages as the traveler becomes more informed about the details of the itinerary.

One of the biggest challenges faced by travelers is the lack of a single, connected system to handle all four phases of travel. Inspiration is often gathered in a system that is not travel-related or specific. Research is often done on the internet, and the results may be gathered in the same way as the inspiration is gathered or may be kept in a system more appropriate for planning the itinerary. And the system for planning the itinerary will not generally be connected to a system for booking.

At this stage, travelers typically rely on platforms focused primarily on reservations and transactions. Examples include Expedia and Booking.com for accommodations, Tripadvisor for activity booking and reviews, and Klook or GetYourGuide for experiences. These systems are optimized for finalizing decisions rather than connecting with earlier phases like inspiration or research. As such, they operate as standalone tools without continuity from the ideas and plans a traveler has previously gathered.

The disclosed system differs by enabling seamless progression from inspiration through booking within a unified framework, maintaining the context and intent captured in earlier phases to inform final reservations.

References Cited
U.S. PATENT DOCUMENTS

| | | |
|---|---|---|
| 10,445,666 B | October 2019 | Lopez |
| 7,925,540 B | April 2011 | Orttung |
| 6,232,915 B | May 2001 | Dean |

### Other Documents

TourSoft Travel Itinerary Builder, accessed Jun. 8, 2025, sso.toursoft.systems Wanderlog travel planner: free vacation planner and itinerary app, accessed Jun. 8, 2025, wanderlog.com
Trip Planner AI: Free & Customizable Travel Itinerary App, accessed Jun. 8, 2025, tripplanner.ai
Wonderplan-Best AI Trip Planner, Free AI Travel Planner, accessed Jun. 8, 2025, wonderplan.ai
AI Trip Builder Tool, accessed Jul. 16, 2025, www.layla.ai
MindTrip.ai, accessed Jul. 16, 2025, mindtrip.ai
Roam Around-Ultimate AI Travel Planner, accessed Jun. 15, 2025, roamaround.app
Lonely Planet Travel Guides & Travel Information, accessed Jul. 15, 2025, www.lonelyplanet.com
Culture Trip: Read Travel Guides & Book Stays And Experiences, accessed Jul. 15, 2025, theculturetrip.com
Triposo, accessed Jun. 15, 2025, en.wikipedia.org/wiki/Triposo Road Trip Planner—Find the best stops along the way | Roadtrippers, accessed Jul. 15, 2025, roadtrippers.com
Sygic Travel Maps, accessed Jun. 8, 2025, www.sygic.com/travel ClickUp™ The everything app for work, accessed Jul. 15, 2025, clickup.com
Notion: The AI workspace that works for you, accessed Jul. 15, 2025, www.notion.com
Expedia Travel: Vacation Homes, Hotels, Car Rentals, Flights & More, accessed Jun. 8, 2025, www.expedia.com
Booking.com | Official site | The best hotels, flights, car rentals & accommodations, accessed Jun. 8, 2025, www.booking.com
Tripadvisor: Over a billion reviews & contributions for Hotels, Attractions, Restaurants, and more, accessed Jun. 8, 2025, www.tripadvisor.com
Klook Travel-Things to do, Accommodation, Transport, accessed Jul. 15, 2025, www.klook.com
Get YourGuide: Book Things To Do, Attractions, and Tours, accessed Jul. 15, 2025, www.getyourguide.com

### OBJECTS AND ADVANTAGES OF THE INVENTION

The object of the invention is to provide a system to facilitate the gathering inspirational travel-related content, in a convenient, unstructured way, requiring little or no forethought on the part of the user; but more importantly, to leverage that travel-related content to automatically, proactively, and without user intervention, start the travel planning process, thereby allowing the user to focus more of their time on the enjoyable travel inspiration process and less on the tedious and detail-oriented planning phases of the process.

This allows the traveler to gather random, unrelated content reflecting their interests and desires in terms of travel, without concern for the specifics required for the planning process. In return, the system that embodies the invention can sort and organize the elements of the travel inspirations shared by the traveler, arrange them into sensible groupings, and present the traveler with one or more bespoke itineraries, incorporating travel features that have inspired the traveler, potentially supplemented with additional recommendations. This allows the user to experience potentially several of their desired travel aspirations, with little or no effort beyond sharing those aspirations and committing to book the itinerary with the system.

### BRIEF DESCRIPTION OF DRAWINGS

FIG. 1. is a diagram describing the process by which the system accepts and processes travel-related content in the form of URLs sent to the system via SMS or MMS.

FIG. 2. is a diagram describing the process by which the system accepts and processes travel-related images and videos sent to the system via MMS.

FIG. 3. is a diagram describing the process by which the system accepts and processes travel-related content in the form of URLs sent to the system via a website or mobile application.

FIG. 4. is a diagram describing the process by which the system accepts and processes messages that it determines are not inspiration-related travel content.

FIG. 5. is a diagram describing the process by which the system processes travel features extracted from the user's travel-related content, along with additional ancillary travel-related information, to generate proposed travel itineraries.

FIG. 6. is a diagram illustrating the overall architecture of the preferred embodiment, showing all the components of the system and how they are connected.

### REFERENCE NUMERALS USED IN DRAWINGS AND DESCRIPTION

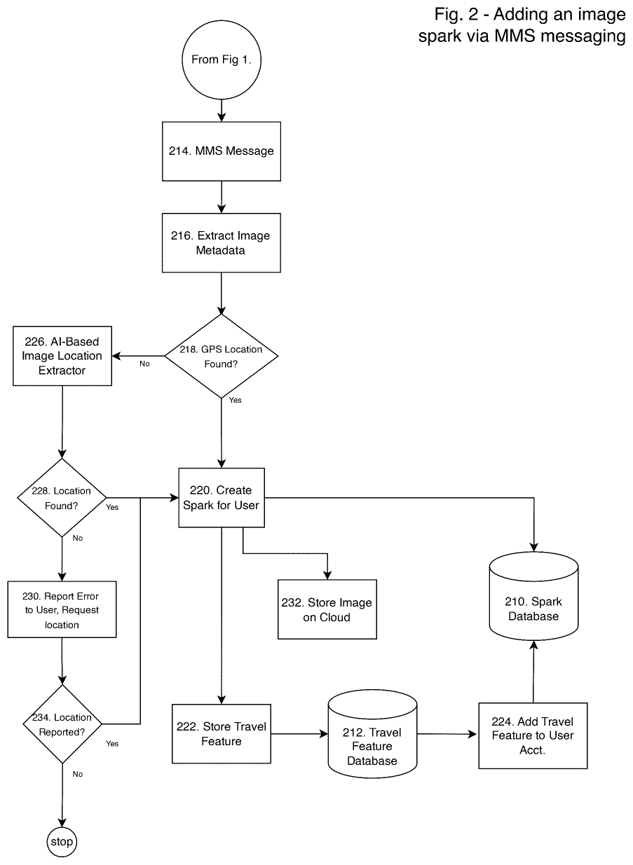

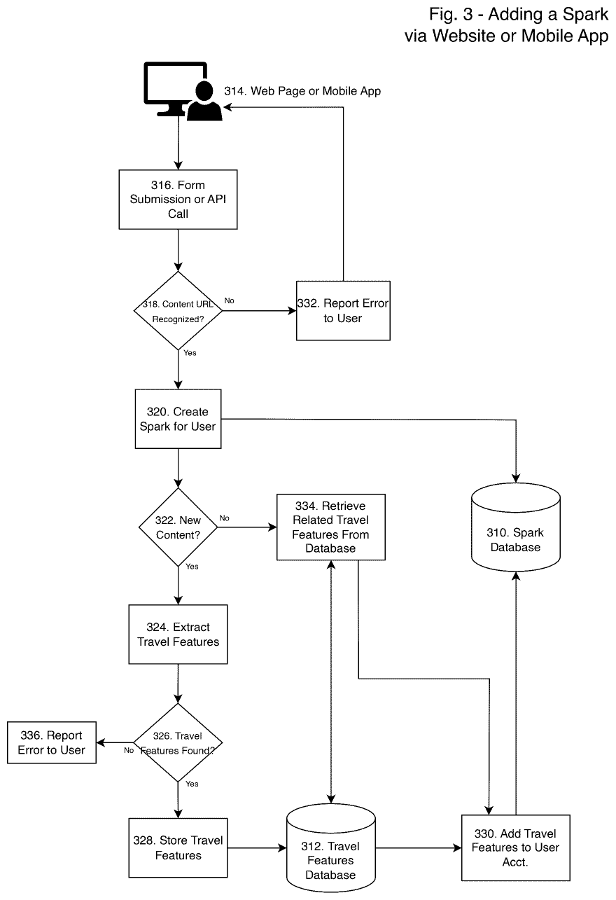

110. A database or set of database tables for storing user's travel-related content (“Sparks”)
112. A database or set of database tables for storing travel features
114. User's mobile device
116. An SMS or MMS message sent by the user
118. A processing test to determine if the user is recognized via the telephone number of the sender's device
120. A processing test to determine if the content submitted is a valid URL.
122. A process by which the system creates a record in the spark database 110 for the user's content submission
124. A processing test to determine if the system has processed the content of the submitted URL previously or if the content is new content
126. An AI-based process by which the system extracts all travel features from the submitted content
128. A processing test to determine if any travel features were found in the content
130. A process by which any new travel features are stored in the travel feature database 112
132. A process by which references to all the travel features found in the submitted content are added to the user's account
134. A process by which the system requests that any unrecognized sender is asked to opt into the system
136. A process by which a system account is created for any unrecognized senders that have agreed to opt into the system
138. A processing test by which the system attempts to determine whether any message not recognized as a URL is in a recognizable image or video format.
140. A placeholder for additional processing steps described in FIG. 2
142. A placeholder for additional processing steps described in FIG. 3
144. A process by which existing travel features associated with submitted URL that has been previously processed are retrieved from the travel feature database
146. A process by which an error is reported to the user
210. A database or set of database tables for storing user's “Sparks” (travel-related content) (same as referenced in 110)
212. A database or set of database tables for storing travel features (same as referenced in
112)
214. An MMS message sent by the user
216. A process by which the metadata attached to an image or video file is extracted from the image or video file
218. A processing test by which the system determines whether the extracted metadata contains GPS location information
220. A process by which the system creates a record in the spark database 210 for the user's content submission
222. A process by which any new travel features are stored in the travel feature database 212
224. A process by which references to all the travel features found in the submitted content are added to the user's account
226. A process by which the system attempts to extract the location and activity information from the image or video, using AI-base image recognition
228. A processing test by which the system determines whether valid location information has been successfully extracted from the image or video file
230. A process by which an error is reported to the user, and the user is prompted to identify the location themselves
232. A process by which the submitted image or video is stored on the cloud
234. A process by which the user submitted response to the prompt included in 230 is processed and forwarded to 220.
310. A database or set of database tables for storing user's “Sparks” (travel-related content) (same as referenced in 110)
312. A database or set of database tables for storing travel features (same as referenced in 112)
314. A web page or mobile application running on a user's device
316. A standard HTTP form submission or API call submitted to the system
318. A processing test by which the system determines whether the submitted content is a valid URL
320. A process by which the system creates a record in the spark database 310 for the user's content submission
322. A processing test to determine if the system has processed the content of the submitted URL previously or if the content is new content
324. An AI-based process by which the system extracts all travel features from the submitted content
326. A processing test to determine if any travel features were found in the content
328. A process by which any new travel features are stored in the travel feature database 112
330. A process by which references to all the travel features found in the submitted content are added to the user's account
332. A process by which the system reports an error to the user
334. A process by which existing travel features associated with submitted URL that has been previously processed are retrieved from the travel feature database
336. A process by which an error is reported to the user
338. A process by which any new travel features are stored in the travel feature database 212
410. A processing decision through which the system determines whether the user account associated with the sender has an active itinerary
412. An AI-based processing decision through which the system determines whether the content submitted by the user is travel-related
414. A processing decision through which the system determines whether the content of the message is itinerary-related or whether it is a general, travel-related question
416. A messaging system used by human agents to manage and respond to user inquiries
418. An AI-based processing test to determine whether a question can be adequately addressed using a large language model AI
420. An AI-based processing test to determine whether a question can be adequately addressed using a large language model AI
422. A process by which the system reports an error to the user
424. An AI-based process by which the system generates an answer to a travel-related question using AI
426. A process by which an error is reported to the user
428. An AI-based process by which the system generates an answer to a travel-related question using AI
512. A database or set of database tables for storing travel features (same as referenced in 112)
514. An itinerary request-either system or end-user-generated
516. A process by which the system retrieves all the travel features associated with the user
518. An AI-based process by which the system clusters into geographically appropriate subsets to aid in the itinerary generation process
520. A database or set of database tables for storing the resultant location clusters
522. A set of coded itinerary characteristics to aid the construction of the proposed itinerary
524. A process by which the clusters are used to determine an appropriate subset of the user's travel features to consider for the proposed itinerary
526. A database of supplemental travel data to aid the AI in making accurate travel planning decisions
528. A process by which the supplemental travel data is filtered and preprocessed for use by the large language model using the retrieval-augmented generation (RAG) method
530. An AI-based process by which the system generates a prompt based on the travel features and the itinerary characteristics and uses a large language model provided with the supplemental travel RAG data to generate an appropriate proposed travel itinerary
532. A database or set of database tables to store the components of the proposed itinerary
534. A process by which the system presents the user with the proposed itinerary (potentially along with numerous others) through potentially many different methods, and by which the user is able to inspect the itinerary and select one to begin the final travel planning process
536. The user inspecting the itinerary
540. A set of user-specified itinerary constraints, including travel dates, the number and ages of travelers, etc.)
542. An AI-based-process by which the system refines the user-selected itinerary using the additional constraints provided
544. A process by which the itinerary is transferred to the traditional travel planning system
546. A database or set of database tables to store the itinerary components for final refinement and booking/execution
610. A collection of third-party services
612. A cloud-based telephony service
614. A cloud-based email service
616. A large language model (LLM) service
618. An AI-based image recognition service
630. A cloud-based server environment on which the described service is deployed
632. A website and mobile application through which the user manages his information
634. A subsystem for managing the system's user-specific information
634a. The system's user manager API, which implements all business logic for managing users
634b. A database or set of database tables for storing user-related data
636. A subsystem for managing Sparks
636a. The system's Spark manager API, which implements all the business logic for managing Sparks
636b. A database or set of database tables for storing user's “Sparks” (travel-related content) (same as referenced in 110)
638. A cloud-based file storage system, hosted on the cloud-based server system 612
640. A subsystem for managing travel features
640a. The system's travel feature manager API, which implements all the business logic and analysis of travel features
640b. A database or set of database tables for storing travel feature-related data
642. A subsystem for managing proposed itineraries
642a. The system's travel feature cluster manager API, which implements all the business logic for travel feature clusters, including their creation
642b. A database or set of database tables for storing travel feature cluster data
642c. The system's proposed itinerary manager API, which implements all the business logic for proposed itineraries, including their creation
642d. A database or set of database tables for storing proposed itinerary data
644. A subsystem for managing the data necessary for retrieval-augmented generation (RAG)
644a. The system's RAG data manager API, which implements all the business logic and analysis of the data necessary for retrieval-augmented generation
644b. A database or set of baseball tables for storing travel-related data for use in RAG large language model processing
646. A traditional travel planning system
646a. The travel planning API, which implements all the business logic for traditional, human-directed travel planning
646b. A database or set of database tables for storing travel itineraries for the traditional travel planning system

### SUMMARY OF THE INVENTION

The system described seeks to do two things:
Integrate the various phases of travel organization into a single system. A user should be able to use the system to span all four stages of the travel organization, from inspiration to booking.
Automate many of the more tedious aspects of travel organization. Taking the limited, “inspiration” information provided by the user, the system can extract travel features from the content the user provided, determine potential travel destinations, enrich the information associated with those travel destinations (“research”), and begin integrating them into coherent, sensible itineraries (“planning”) for the user to browse and refine-either on their own or in conjunction with a travel advisor. Finally, through its integration with an existing, traditional travel planning system, the resultant itineraries can be easily “booked”.

The end result is an environment where the traveller casually goes about their normal content consumption-social media, magazines, etc., and shares with the invention the things they find interesting. In response, the invention offers a selection of well-planned and well-researched itineraries, varying in length, budget, and areas of focus both geographically and in terms of traveler interest, that include some or all of the travelers' expressed points of interest and activities. The ready availability of interesting and actionable itineraries increases the likelihood that the traveller will act on their desire to travel, and the power of automation allows for several options to be presented without significant concern for the cost of the planning process.

### DETAILED DESCRIPTION OF THE PREFERRED EMBODIMENT

### Sharing Travel Inspirations (Sparks) with the System

The system is driven by inspirational travel-related content that users share with the system. Users share travel inspirations (Sparks) with the Ravel system through various methods.

Sending a URL via SMS or MMS Message with Optional Annotations

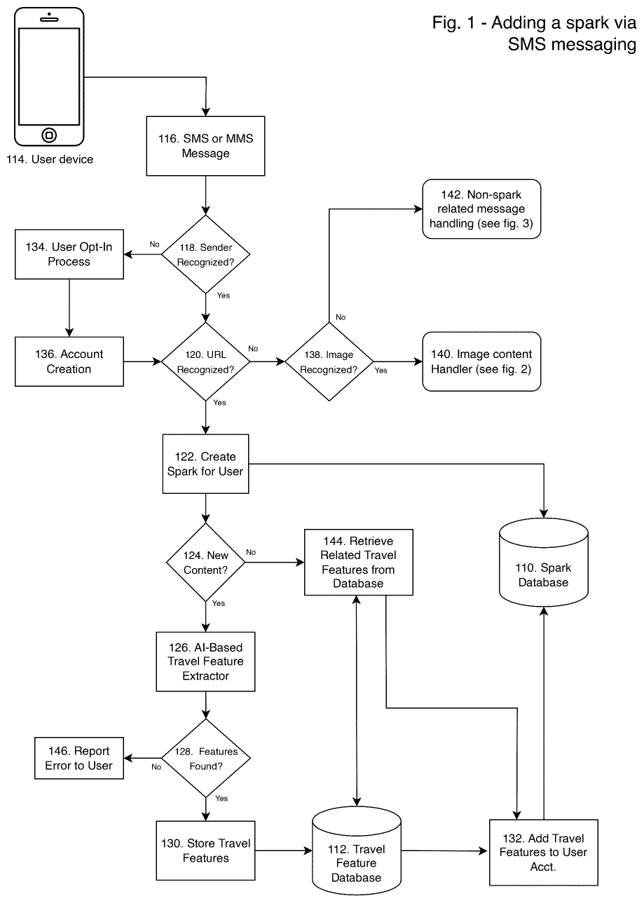

### (See FIG. 1.)

The user can send a URL to the system via SMS. From their device 114 the user can send an SMS message 116 containing a URL to be added to the user's spark collection. The system will look up the sending telephone number to see if the number already exists in the system 118 and if not, it will redirect to a user opt-in process 134 where the user will confirm via SMS that they are consenting to receive SMS messages from the system. If they agree, an account will be created for the user 136.

Once the account is established, the content of the message is analyzed 120. If the content is not recognized as a spark (either a URL or an image or video) then the content is analyzed for potential additional processing.

If the content of the SMS message is recognized as a URL, a spark record is created 122 in the spark database 110 for the user.

The system then evaluates the URL provided 124.

### Travel Feature Extraction

If this is the first time this particular URL has been submitted to the system, the system will route the URL to the AI-Based Travel Feature Extractor 126. The Travel Feature Extractor parses the contents referred to in the URL. It extracts all the locations, activities, accommodations, restaurants, and attractions (generally referred to in the system as “travel features”) referred to in the content referenced by the URL. As part of the travel feature extraction process, the information extracted or otherwise determined can include (but is not limited to)—
A simple name
A brief description
An address (if appropriate)
A URL for the travel feature's website
GPS coordinates
Categorization tags

If travel features are found, a record of the URL will be added to the database, and all the travel features extracted from the URL will be added to the database if necessary (they already exist in the database through references from other URLs). References to the relevant travel features will also be added to the database record for the URL.

If the URL already exists in the database, the system retrieves the related travel features previously extracted from the URL 144.

Whether extracted for the first time or stored in the database from a previous submission of the URL, the resultant travel features are also added to the user's collection of travel features and are marked as being associated with the spark record created for the user 132.

Sending an Image or Video via MMS Message with Optional Annotations

If the content is recognized as an image or video 138, sent through MMS, the content is routed through the image content processor (See FIG. 2.)

The image content processor begins by extracting any available metadata attached to the image or video file 216. Most modern smartphones have the ability to attach metadata to the image and video files generated on the device. If the system can determine the location of the image or video file based on the metadata 218, that location is used in further processing.

If the image metadata does not contain location information, an AI-based image recognition system 226 is used to determine the location of the image, including any landmarks. Any identifiable activities are also identified. If the location is not successfully identified, the system reports an error back to the user 230 informing them that an image or video could not be determined for the submission. The user is also prompted to identify the location themselves, if possible and processing proceeds if they do 234.

If a location has successfully been determined for the image or video, the system creates a spark record 220 for the user in the spark database 210. A copy of the image or video is stored on the cloud 232 and a reference to it is stored with the spark record. The associated travel feature is stored 222 in the travel feature database 212, and a reference to it is also stored 224 in the spark record for the user in the spark database 210.

### Handling Non-Spark Related Messages

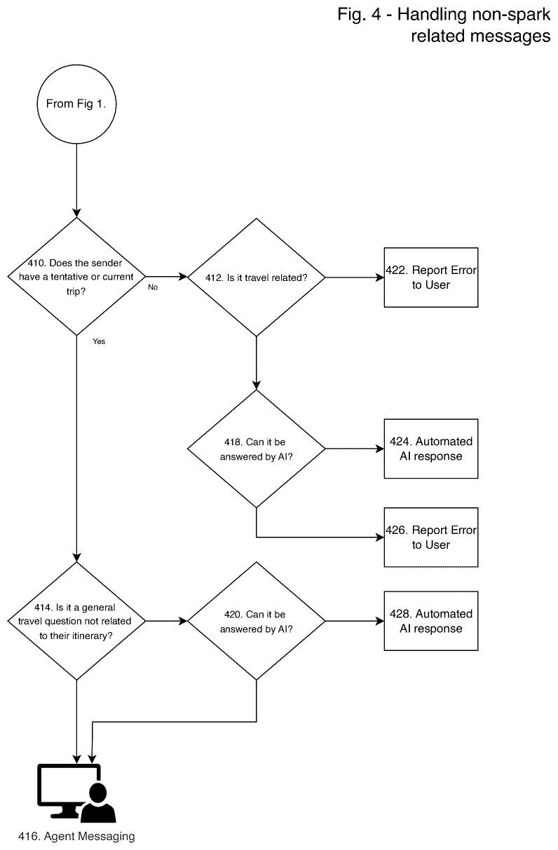

### (See FIG. 4.)

If neither a URL nor an image is found in the message, the system checks the user database to determine if the user has a tentative or current trip in progress 410. This allows for priority handling of users who are currently actively planning an itinerary or are currently traveling on an itinerary.

If the sender is determined to have a tentative or active trip, AI is used to determine whether it is a general travel-related question or if it is determined to be specific to the sender's itinerary 414.

If it is a general, travel-related question, AI is used to determine if a suitable AI answer to the question can be generated 420. If it can, the answer is generated 428 and returned to the user.

If the AI determines it can't address the question adequately, the message is forwarded to an agent messaging system that will route the question to a human agent to address 416.

Similarly, if the question does not appear to be a general travel-related question and/or is related to their specific itinerary, the message is also forwarded to the agent messaging system 416.

If the sender does not have a tentative or active trip currently, the content is analyzed to determine if it is content is travel-related 412. If the content is not travel-related, the system returns an error to the sender immediately 422.

Non-travel-related questions are immediately returned to the user as an error 422.

The system then uses AI to determine if an appropriate, AI response can be generated for the question 418. If an appropriate response can be generated, the answer is then returned to the sender 424.

If a response can not be generated, an error is returned to the sender 426.

### Adding a Spark by Directly Entering a Link Into a Webpage or Via an

### (See FIG. 3.)

The web page uses an HTML form to accept a URL input from the user 314. Upon submission 316 the URL, along with information identifying the user is posted to the system server. The system first evaluates the submission to determine whether the content is a valid URL 318. If it is not, the system returns an error 332 to the website 314 which in turn presents the error to the user.

Note: Moving forward, the system behaves identically to a URL submitted via SMS or MMS, as illustrated in FIG. 1, 122.

Once the content has been determined to be a proper URL 318, a spark record including the URL is created for the user 320 and added to the spark database 310.

### Travel Feature Extraction

The system then evaluates the URL provided 322. If this is the first time this particular URL has been submitted to the system, the system will route the URL to the AI-Based Travel Feature Extractor 324. The Travel Feature Extractor parses the contents referred to in the URL. It extracts all the travel features, activities, accommodations, restaurants, and attractions (generally referred to in the system as “travel features”) referred to in the content referenced by the URL.

As part of the travel feature extraction process, the following information is also extracted or otherwise determined—
A simple name
A brief description
An address (if appropriate)
A URL for the travel feature's website
GPS coordinates
Categorization tags

The system then checks to see if the URL has been analyzed by the system previously 322. If the URL already exists in the database, the system retrieves the related travel features previously extracted from the URL 334.

Whether extracted for the first time or stored in the database from a previous submission of the URL, the resultant travel features are also added to the user's collection of travel features, and are marked as being associated with the spark record created for the user 330.

### Generating Travel Itineraries

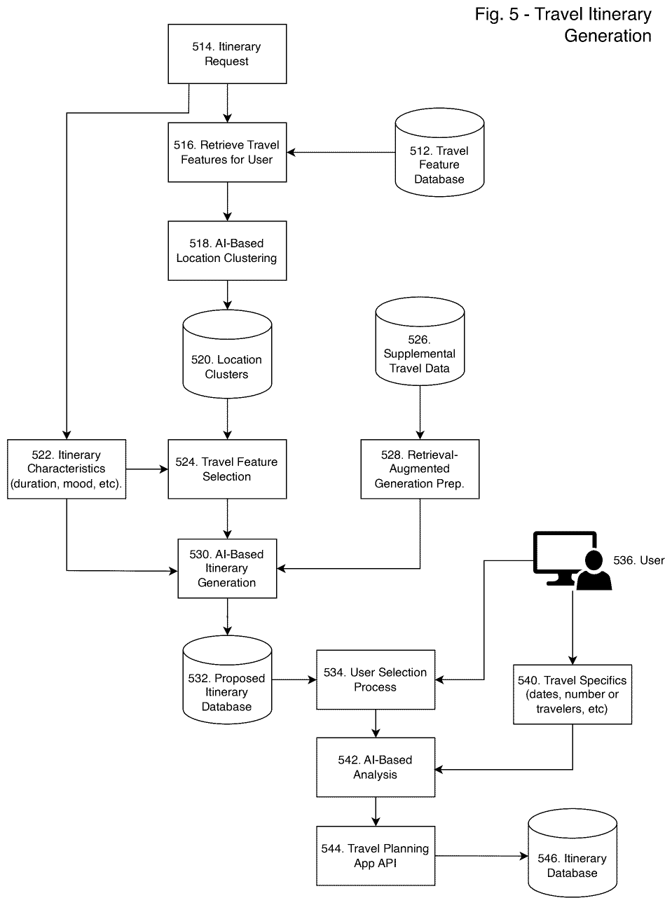

### (See FIG. 5.)

The system makes extensive use of AI, in conjunction with internal, proprietary data to generate itineraries. To obtain the best results, the itinerary generation task has been carefully broken down into several sub-tasks-allowing the AI prompts for each sub-task to focus on one small aspect of the overall task.

Itinerary generation is performed in response to a request 514. Requests can be user-initiated or generated through automated processes.

After receiving the request, the system retrieves all the travel features associated with the user's Sparks 518.

### Geographic Clustering of Travel Features

A user focused on a specific trip may have a clean collection of travel features that can form the basis of a good itinerary. And that may often be the case. But the intent of the system is to allow users to collect disparate pieces of travel information without necessarily having a specific itinerary in mind. It is easy to imagine a user being inspired both by some travel feature in Ireland, and some travel feature in the South Pacific, and wanting to memorialize both without ever envisioning them both being included in a single travel plan.

In order to present the itinerary generation system with a sensible list of travel features from which to build an itinerary, the system performs a multi-tiered clustering process to group travel features into appropriate clusters 518. The underlying principle in the clustering methodology is to divide travel features logically based on travel distance.

The first clustering tier is relatively coarse. The underlying goal is to arrive at a set of regional clusters where each pair of regional clusters is distant enough that a traveler would be unlikely to travel to any two within one week.

Within each set of regional clusters, the travel features are further clustered into accommodation clusters. If the user has tagged any specific accommodations, the system will generally seed the cluster with those travel features. It will then attempt to cluster the travel features within the regional cluster so they are close enough in distance for day travel from the anchoring travel feature.

It will then arbitrarily cluster the remaining locations and will use the travel feature closest to the center of the cluster as the cluster's anchor travel feature.

Both regional clusters and accommodation clusters are stored in a database for potential use in the generation of multiple itineraries 520. If current clusters already exist relative to the user's travel feature collection, the geographic clustering process is not necessary and the existing clusters will be used.

### Itinerary Generation Mechanism

Itineraries are generated using a combination of the user's travel features and a set of itinerary characteristics that can either be explicitly set by the user or automatically generated by the system. In the latter case, this is generally done to probe the range of possible itineraries available to the user based on their travel features. These will be presented to the user to gauge their response, and thereby gain insights into the travel preferences of the user.

### Itinerary Characteristics

The system is designed to generate travel itineraries based on a combination of the travel features extracted from the user's shared Sparks, and a collection of itinerary characteristics defining and/or influencing the itinerary 522. As mentioned—these itinerary characteristics can either be specified by the user or automatically generated by the system.

Those factors include (but are not limited to):
Duration—how many days, including travel to the initial destination and travel back from the final destination.
Seasonality—a targeted time of year for this specific itinerary. This allows the system to tailor activities to the season and suggest specific travel features for that time of year.
Personalization—itineraries can be optimized for the traveler's interests-such as cuisine, the arts, sports, etc.
Level of detail—the system is designed to generate itineraries and varying levels of detail, from a brochure-level overview to itemized, day-by-day accommodations, activities, travel plans, etc.
Theme—the system is capable of generating itineraries with a specific theme. Themes include (but are not limited to):
   Cultural—focused on cultural travel features, such as museums, theatres, monuments, etc.
   Romantic—generally more open-ended and less hurried.
   Family—focused-targeted at families with children.
   Adventure—including more strenuous and outdoor-focused activities.

Note that the theme affects the actual travel features of the itinerary, as well as the description provided for each travel feature.

### Travel Feature Selection

An AI-assisted process is used to select a set of travel features for itinerary construction 524. If the user has specifically requested a trip in a specific region, the corresponding regional cluster will be used to generate the itinerary. If the trip is longer than 7 days and the number of travel features in the region is small, it may propose a trip including one or more additional adjacent regional clusters.

For system-generated itineraries, clusters are used to determine a proper set of the user's travel features for use in the itinerary. For a 7-day or shorter itinerary, a single regional cluster is used. For trips longer than 7 days, may use one or more regional clusters. If a large number of travel features exist in a single regional cluster, the system may determine that the cluster has enough user interest to propose a longer itinerary in that region. Otherwise, it may incorporate all or parts of an additional, adjacent regional cluster.

### Generating Proposed Itinerary

An AI-based itinerary construction process is used to assemble a proposed itinerary. A prompt is constructed using the selected travel features and the desired itinerary characteristics, which can then be fed into a large language model. In addition, proprietary travel data is provided to the large language model 526 using a common AI method called retrieval-augmented generation 528. This proprietary travel data is assembled from internal, organizational expertise, the results of previously proposed and planned itineraries, and carefully selected third-party resources.

The prompt is sent to the large language model 530 and the itinerary is output in a structured, program-readable format such as JSON. The prompt allows enough flexibility for the process to exclude some of the travel features if necessary, or to supplement the travel features with recommendations based on the other travel features and the theme of the itinerary. The proposed itinerary is stored in a database 532 where it can be retrieved and proposed to the user through a variety of mechanisms and channels 534.

### Creating a Tentative Trip

The system may generate several itineraries based on the user's derived travel features and any or all of them may be proposed to the user 534. When the user sees a proposed itinerary they want to experience, they create a tentative trip. This entails finalizing travel dates and defining the list of travelers and any other travel specifics 540. They can also request any changes from the initial proposed itinerary they'd like to make. An additional AI-based analysis is performed to refine the itinerary—to factor in the requested changes and to account for any seasonal changes implied by the actual travel dates 542. The itinerary is transferred to a traditional travel planning system 544 (where any additional changes can be made manually) and a travel advisor assists in finalizing and booking the trip.

### Additional and Alternative Embodiments

Although one specific embodiment is described, several variants are possible and contemplated by the inventors.

Several additional methods by which a user can share their Sparks with the system are possible. For instance automated agents can be implemented in most social media applications, such that the described system could be available as an automated presence in that social media environment. In that context, users could simply share their travel inspirations with the automated agent, which would then add them to their collection of Sparks in the system.

Similarly, the inventors contemplate an automated email service by which travel inspiration is sent to the system via email, and the system processes the information in the email message.

The inventors also contemplate the possibility of a group of people using the system to plan travel together. In that context, Sparks from several users would be pooled into a common set, and itinerary generation would be performed on that common set. The resultant itineraries would then be shared with all the participants in the group. Additionally, the itinerary generation can automatically be tuned to include activities, accommodations, etc. that are particularly appropriate for groups of the size indicated by the number of participants in the group planning.

### DESCRIPTION OF TECHNICAL COMPONENTS

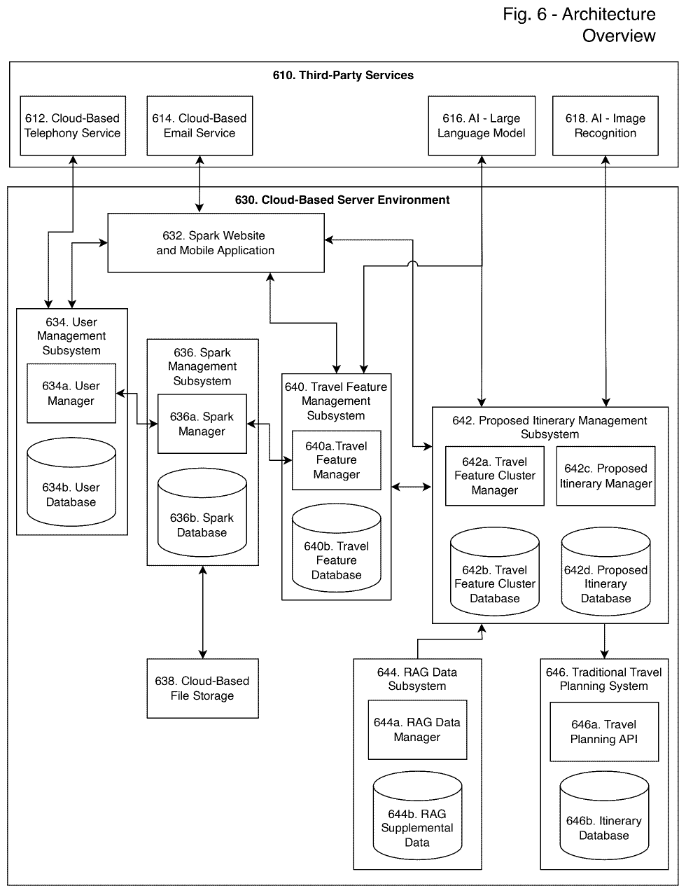

FIG. 6 illustrates the overall architecture of the system.

### Third-Party Services 610

The system relies on several third-party services.

### Cloud-based Telephony System 612

The system uses a third-party telephony system to route SMS and MMS messages from users to the system and from the system to the user.

### Cloud-based Email System 614

The system uses a third-party email system to send and receive email messages from users.

### AI-Large Language Model 616

The system uses one or more third-party large language models (LLMs) to perform various processing tasks.

### AI-AI-Image Recognition 618

The system uses one or more third-party image recognition systems to process single-frame images and videos submitted by users.

### Cloud-Based Server Environment 630

The system's services run are implemented using proprietary code hosted on a cloud platform, with core functionality implemented using Python and the Django framework. The Cloud-Based Server Environment also includes the database storage used by the various components of the system. The database storage system is implemented using the PostgreSQL database system.

### Spark Website and Mobile Application 632

Users manage their Sparks via a web or mobile app. The website is implemented in next.js and hosted on the server environment. The mobile application is implemented in React Native.

### User Management Subsystem 634

The User Management Subsystem is an application programming interface that manages user-specific data. This includes several components.

### User Manager 634a

The User Manager implements the business logic necessary to manage user account information, including but not limited to user credentials (email, phone number, password), and user preferences.

### User Database 634b

All user-specific data is stored in the User Database. The User Database is implemented as a database instance or a set of database tables implemented on the PostgreSQL database environment running on the system's Cloud-Based Server Environment.

### Spark Management Subsystem 636

The Spark Management Subsystem is an application programming interface that manages spark-specific data. This includes several components.

### Spark Manager 636a

The Spark Manager implements the business logic necessary to manage user-submitted sparks, including but not limited to the submitted content URL and related metadata, a reference to a cloud-stored image or video, and related metadata.

### Spark Database 636b

All spark data is stored in the Spark Database. The Spark Database is implemented as a database instance or a set of database tables implemented on the PostgreSQL database environment running on the system's Cloud-Based Server Environment.

### Cloud-Based File Storage 638

The system stores images and videos submitted by users, as well as any other ancillary files on a file storage system on the Cloud-Based Server Environment.

### Travel Feature Management Subsystem 640

The Spark Management Subsystem is an application programming interface that manages travel feature data. This includes several components.

### Travel Feature Manager 640a

The Travel Feature Manager implements the business logic necessary to manage the travel features extracted from the user-submitted sparks. This includes but is not limited to a name, a description, an address, a link to the travel feature's website, a latitude and longitude, and one or more categorization tags.

The Travel Feature Manager also performs AI-Based Travel Extraction process using the Large Language Model Service 616 and the AI-Based Image Recognition Service 618.

### Travel Feature Database 640b

All travel feature data is stored in the Travel Feature Database. The Travel Feature Database is implemented as a database instance or a set of database tables implemented on the PostgreSQL database environment running on the system's Cloud-Based Server Environment.

### Proposed Itinerary Management Subsystem 642

The Proposed Itinerary Management Subsystem is an application programming interface that manages AI-generated proposed itineraries. It includes several components.

### Travel Feature Cluster Manager 642a

The Travel Feature Cluster Manager implements all the business logic necessary to manage the travel feature clusters. This includes using the LLM system 616 to create travel feature clusters.

### Travel Feature Cluster Database 642b

The data that describes the resultant travel feature clusters are stored in the Travel Feature Cluster Database. The Travel Feature Cluster Database is implemented as a database instance or a set of database tables implemented on the PostgreSQL database environment running on the system's Cloud-Based Server Environment.

### Proposed Itinerary Manager 642c

The Proposed Itinerary Manager implements the business logic necessary to manage proposed itineraries. This includes using the LLM system 616 and supplemental data from the RAG subsystem 644 to generate new proposed itineraries.

### Proposed Itinerary Database 642d

The data that describes the proposed itineraries are stored in the Proposed Itinerary Database. The Proposed Itinerary Database is implemented as a database instance or a set of database tables implemented on the PostgreSQL database environment running on the system's Cloud-Based Server Environment.

### Retrieval-Augmented Generation (RAG) Subsystem 644

The data necessary to implement Retrieval-Augmented Generation is managed, processed, and staged by the RAG Data Subsystem. It includes several components.

### RAG Data Manager 644a

The RAG Data Manager implements all the logic necessary to sort, select, and stage the supplemental travel data to be used in the proposed itinerary generation process.

### RAG Supplemental Data 644b

The RAG supplemental database stores all the supplemental travel data used by the RAG Data Manager to create the data set sent to the LLM system.

### Traditional Travel Planning System 646

The described system integrates with an existing traditional travel planning system to allow itineraries to be staged for booking. Additional changes and/or refinements can be made to the itinerary once it is transferred to the traditional travel planning system.

### Travel Planning System API 646a

The described system integrates with the existing traditional travel planning system is accomplished through an application programming interface.

### Itinerary Database 646b

The traditional travel system stores information that describes the itinerary using a database or a set of database tables, running on the cloud-based server environment 630.

What is claimed is:

1. A computer-implemented method for collecting and organizing travel-related content, comprising:
receiving, via a user computing device, an unclassified, user-submitted content item comprising at least one of a URL, image, audio, or video;
extracting one or more travel features from the content, wherein the travel features comprise information selected from the group consisting of, but not limited to: name, description, address, URL, and GPS coordinates;
categorizing travel features based on likely appeal to traveler interest groups;
clustering the travel features, along with those derived from any previous user submissions, based on geographic proximity into one or more regional clusters and accommodation clusters;
storing the extracted travel features and any extracted or generated metadata in a travel feature database; and
organizing the extracted travel features into a user-specific collection for subsequent itinerary generation.

2. A computer-implemented method for generating a travel itinerary based on user-collected travel features, comprising:
retrieving from a database a set of travel features and related metadata previously collected and associated with a user;
generating a proposed travel itinerary by selecting travel features based on the itinerary characteristics and clustered travel features; and
outputting the proposed travel itinerary in a structured, program-readable format.

3. The method of claim 1, wherein the content item comprises an image or video, and the travel feature extractor uses image recognition to identify a geographic location and one or more associated travel features.

4. The method of claim 1, further comprising storing the content item in a record associated with the user in a database.

5. The method of claim 2, wherein generating the proposed travel itinerary includes proprietary travel data into guide and supplement the itinerary creation.

6. The method of claim 2, wherein the itinerary characteristics include a theme selected from the group consisting of: cultural, romantic, family-focused, and adventure.

7. The method of claim 2, further comprising enabling the user to refine the proposed itinerary and finalize a tentative trip that can be transferred to a traditional travel planning system for booking.
